(19) United States
(12) Patent Application Publication
(10) Pub. No.: US 2004/0118642 A1
(43) Pub. Date: Jun. 24, 2004

(54) DISC BRAKE FOR LAND VEHICLES

(75) Inventors: Johan HULTEN, Goteborg (SE); Ingemar DAGH, Goteborg (SE)

Correspondence Address: TRACY W. DRUCE, ESQ., 1496 EVANS FARM DR, MCLEAN, VA, 22101, US

(73) Assignee: VOLVO TRUCK CORPORATION, Goteborg (SE)

(21) Appl. No.: 10/707,795

(22) Filed: Jan. 13, 2004

Related U.S. Application Data
(63) Continuation of application No. PCT/SE02/00936, filed on May 16, 2002.

(30) Foreign Application Priority Data
Jul. 13, 2001 (SE) 0102534-5

(51) Int. Cl. F16D 55/08

(52) U.S. Cl. 188/72.7; 188/72.9

(57) ABSTRACT

Method and arrangement for providing a disc brake (1) for land vehicles having a brake disc (2) rotating with a wheel axle (3). A brake caliper (4) is mounted in a movable manner in a nonrotating wheel-axle housing that is arranged about said wheel axle (3). The two brake linings (5), one on each side of the brake disc (2), are configured in such a way that, when acted upon by an activating mechanism (8), they are caused to bear against the sides (9) of the brake disc (2) for transmitting a braking torque to the wheel axle (3). The brake caliper (4) includes two brake-lining holders (10, 11) which are axially displaceable relative to one another and relative to the wheel-axle housing (3). The brake-lining holders (10, 11) each have at least one actuation surface (12, 13, 14, 15)for engagement with the activating mechanism (8), as a result of which the brake-lining holders (10, 11) are displaced toward each other upon activation.

### CROSS REFERENCE TO RELATED APPLICATIONS

The present application is a continuation patent application of International Application No. PCT/SE02/00936 filed 16 May 2002 which was published in English pursuant to Article 21(2) of the Patent Cooperation Treaty, and which claims priority to Swedish Application No. 0102534-5 filed 13 Jul. 2001. Both applications are expressly incorporated herein by reference in their entireties.

### BACKGROUND OF INVENTION

1. Technical Field

The present invention relates to a disc brake for land vehicles, in particular for heavy commercial vehicles such as trucks and buses.

2. Background

Disc brakes are now commonly used on heavy vehicles, even if they were introduced relatively recently compared to their use in passenger vehicles and other light vehicles, where disc brake technology has long been well established.

The main type of disc brake for heavy vehicles is pneumatically activated and comprises (includes, but is not limited to) a conventional type floating brake caliper over a brake disc rotating with the wheel axle, and a holder for two brake linings. The holder has support surfaces for taking up the forces to which the brake linings are exposed during braking. The brake is generally activated by a piston rod from a pneumatically driven brake cylinder pressing upon a lever which transmits the force, via a force transmission mechanism, to two brake pistons that in turn press against one of the brake linings. In this case, force is also transmitted in a known manner to the other, opposite brake lining via the floating brake caliper, resulting in the brake linings being pressed against both sides of the brake disc. An adjustment mechanism is designed to continuously compensate for the wear of the brake linings during their useful life.

The conventional disc brake described above has many good properties such as good reliability, low vibrations and low noise level. It also has a high degree of resistance to crack formation as a result of the relatively heavy and powerful brake caliper. However, the design is also associated with a number of disadvantages. One important disadvantage is that heat is transmitted directly from the brake linings to the brake journals and onward into the sensitive force transmission mechanism. The brake pistons are generally sealed off against dirt and dampness by means of grease and sealing bellows made of rubber or some other flexible material, which after some time tend to become damaged by the high degree of heat.

Another disadvantage is that the floating brake caliper has to easily slide so that the brake can function satisfactorily. The brake caliper also supports the activating mechanism, the adjustment mechanism and the brake cylinder, for which reason the mass of the floating part is great. The great mass results in great stresses on the suspension bushings of the brake caliper when the brake is exposed to vibrations from the road surface, which results in increased wear of the suspension bushings.

Moreover, the brake caliper, the brake linings and the brake pistons are all arranged to be able to slide, which involves a large number of expensive function surfaces. During braking, very high stresses also arise on these slide surfaces, which, in addition to causing increased wear, also means that the function surfaces have to be given substantial dimensions. At the surface between brake lining and brake-lining holder, there is also a sliding of metal against metal.

Finally, the whole brake disc has to be dismantled in order for the wheel hub to be able to be subsequently dismantled, which represents a disadvantage in terms of maintenance.

### SUMMARY OF INVENTION

Against the background of the abovementioned disadvantages of the conventional disc brake, a need has been identified for a novel disc brake design, which avoids said disadvantages. The invention therefore makes available a disc brake, namely for land vehicles, that is characterized by a brake disc that rotates with a wheel axle. A brake caliper is included that is mounted in a movable manner in a non-rotating wheel-axle housing that is arranged about the wheel axle. Two brake linings, one on each side of the brake disc, are each designed in such a way that, when acted upon by an activating mechanism, they are caused to bear against the sides of the brake disc for transmitting a braking torque to the wheel axle. The brake caliper comprises two brake-lining holders which are axially displaceable relative to one another and relative to the wheel-axle housing. The brake-lining holders each have at least one actuation surface for engagement with the activating mechanism, and as a result of which the brake-lining holders are displaced toward each other upon activation.

In one specific embodiment, the brake-lining holders have attachment seats for the brake linings that are placed at a distance from the actuation surfaces.

In an advantageous embodiment of the invention, an outer brake-lining holder is designed such that, in the axial direction of the wheel axle, it at least partially surrounds an inner brake-lining holder. The actuation surface of the inner brake-lining holder is in this case directed toward a corresponding actuation surface of the outer brake-lining holder.

The previously mentioned activating mechanism is preferably axially fixed in relation to the wheel-axle housing and comprises a separating member acting between the actuation surfaces for the purpose of mutual axial displacement of the brake-lining holders. The separating member consists of a cam element, which cam element is rotatable about a camshaft extending substantially at right angles to the wheel axle. In an expedient embodiment, the cam element consists of a S-cam. The cam element can also consist of a so-called Z-cam, or a cam profile of involute type. Alternatively, the separating member can also have a wedge-shaped cross section.

In a suitable embodiment, needle-roller bearings are placed between the cam element and the actuation surfaces.

Moreover, in an expedient embodiment, an activating lever is connected in a rotationally fixed manner to the camshaft. The activating lever has an end portion designed for actuation by an actuator rod from a power member, such as a pneumatic actuator cylinder, or alternatively an angled gear or other type of gear that can also be used to turn the camshaft.

In a preferred embodiment, the brake-lining holders are both arranged so as to slide along two mutually substantially parallel suspension axles, which are likewise substantially parallel to the wheel axle and are secured in the wheel-axle housing.

Finally, in a maintenance-friendly embodiment, the outer brake-lining holder is articulated so that it can be pivoted upward about one of the suspension axles between a downwardly pivoted operating position and an upwardly pivoted maintenance position for replacing the brake linings.

### BRIEF DESCRIPTION OF DRAWINGS

Embodiments of the invention will be described in greater detail below with reference to the accompanying drawings, in which:

FIG. 1 is a partial cutaway top view of a preferred embodiment of a disc brake configured according to the invention and with the brake shown in an unactivated position;

FIG. 2 is a partial sectional view, taken along dot-and-dash line 2-2 of FIG. 1, showing a separating member in the form of an S-shaped cam element;

FIG. 3 is a partial sectional view, taken along dot-and-dash line 3-3 of FIG. 1, showing an activating lever in cutaway view;

FIG. 4 is a partial cutaway top view of a preferred embodiment of a disc brake configured as in FIG. 1, but with the brake shown in an activated position;

FIG. 5 shows a simplified sectional view of the disc brake, where the outer brake-lining holder is shown in a downwardly pivoted operating position (solid lines) and in an upwardly pivoted maintenance position (dashed lines);

FIG. 6 shows a partial sectional view of a cam element configured according to an alternative embodiment of the invention; and

FIG. 7 shows a partial sectional view of a cam element configured according to another alternative embodiment of the invention.

### DETAILED DESCRIPTION

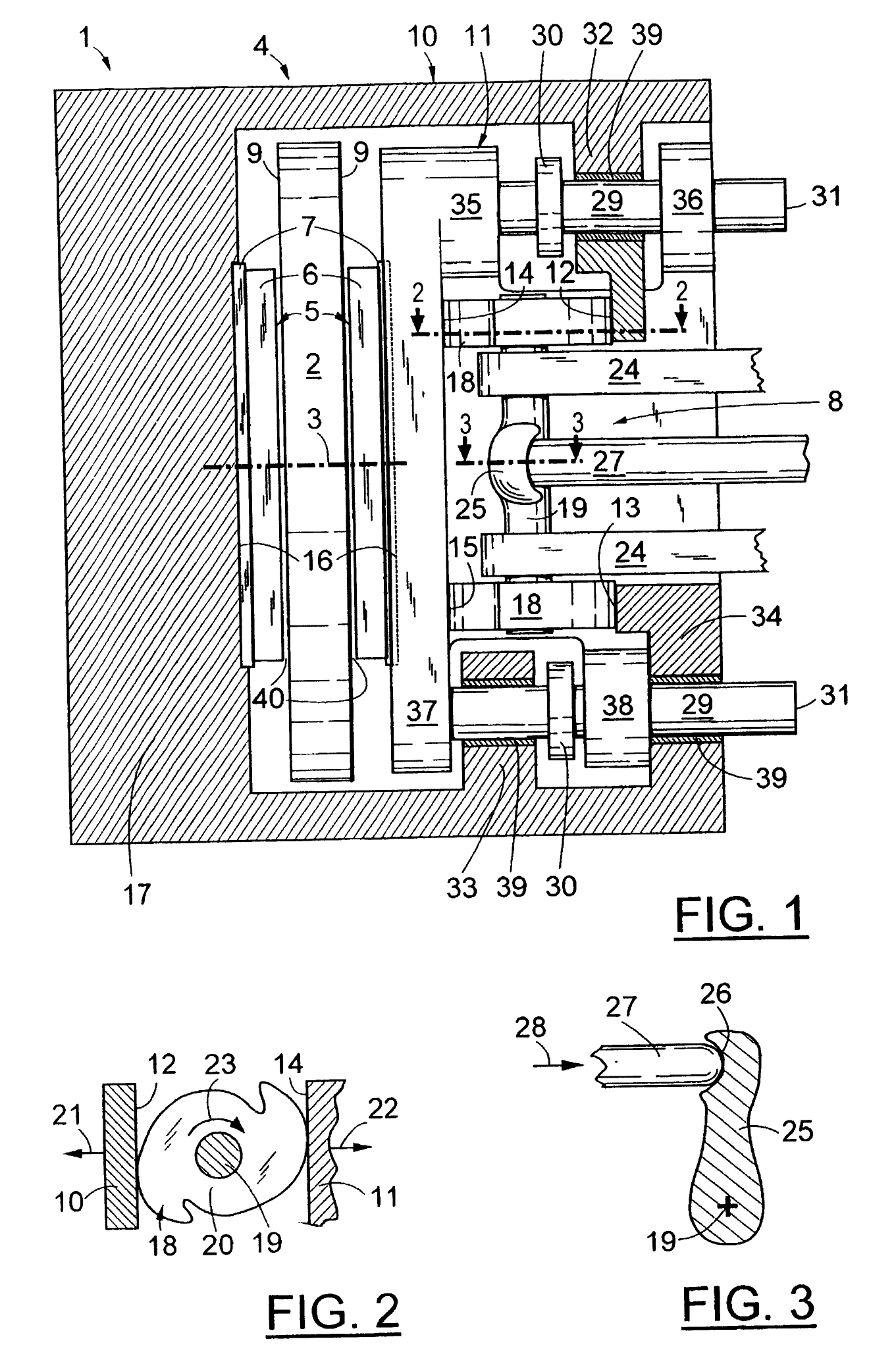

Reference number 1 in FIG. 1 designates generally a disc brake configured according to the invention, typically for a land vehicle, and in particular, for heavy commercial vehicles such as trucks and buses.

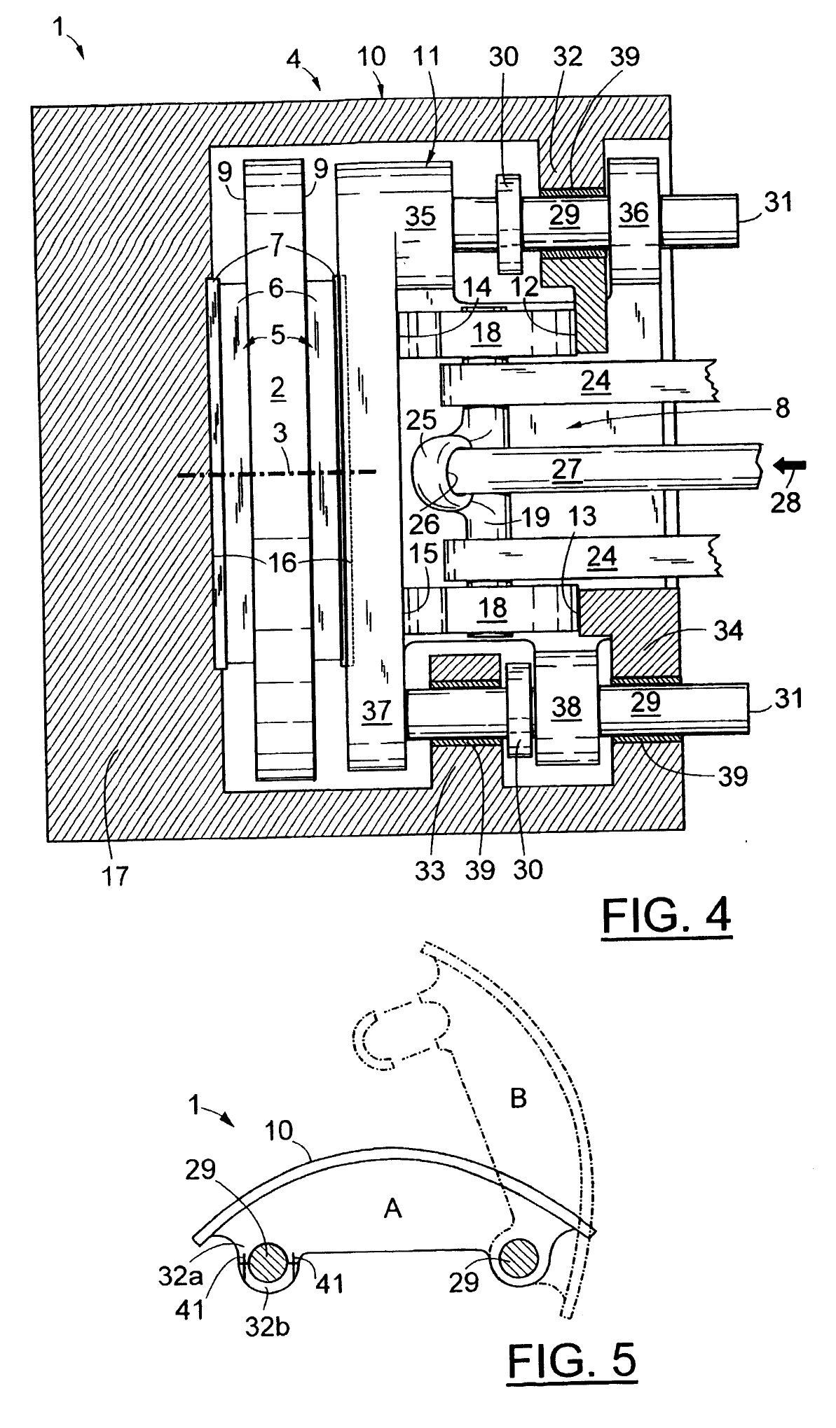

The disc brake 1 comprises a brake disc 2 which rotates a with a wheel axle 3. The wheel axle 3 is indicated only by a dot-and-dash line in FIG. 1 and in FIG. 4. The brake disc 2 is of a conventional type and is only drawn diagrammatically in the figures. As will be appreciated by those persons skilled in the art, the arrangement may include ventilation orifices (not shown) and can be fixed in terms of rotation to the wheel axle 3 by a spline coupling (not shown).

The disc brake 1 also comprises a brake caliper 4 mounted in a movable manner in a non-rotating wheel-axle housing secured to the vehicle and arranged about the wheel axle 3. The term wheel-axle housing here includes both rear-axle housing and spindles and steerable spindles.

Two brake linings 5, one on each side of the brake disc 2, are also held in place by the brake caliper 4. The brake linings 5 each consist in a conventional manner of a friction plate 6 made of a material with high heat resistance, and of a support plate 7, usually made of metal, which is secured to the rear; i.e., on that side of the brake lining 5 facing away from the brake disc 2. In an alternative embodiment, the friction plate 6 can be used without support plate 7. The brake linings 5 are designed in such a way that, when acted upon by an activating mechanism 8, they are caused to bear against the sides 9 of the brake disc 2 for transmitting a braking torque to the wheel axle 3.

According to the invention, the brake caliper 4 comprises two brake-lining holders 10, 11 which are axially displaceable relative to one another and relative to the wheel-axle housing. As can be seen from FIG. 1, an outer brake-lining holder 10 is designed such that, in the axial direction of the wheel axle 3, it completely surrounds an inner brake-lining holder 11. However, in an alternative embodiment, it is contemplated that the outer brake-lining holder 10 can instead be designed such that it only partially surrounds the inner brake-lining holder 11. The outer brake-lining holder 10 is caliper-shaped and extends with an overhanging portion 17 over the brake disc 2. In this respect, the outer brake-lining holder 10, viewed from the outside, resembles a traditional brake caliper, despite the fact that its function differs from a traditional brake caliper.

The brake-lining holders 10, 11 each have two actuation surfaces 12, 13 and 14, 15, respectively, for engagement with the activating mechanism 8, by which means the brake-lining holders 10, 11 are displaced toward each other and toward the brake disc 2 upon activation. The brake-lining holders 10, 11 are further provided with attachment seats 16 for the brake linings 5 that are placed at a distance from the actuation surfaces 12, 13, 14, 15. This arrangement avoids substantial heat transfer from the brake linings 5 directly to the activating mechanism 8, which, compared to conventional disc brakes, is a great advantage from the point of view of operational reliability.

The actuation surfaces 14, 15 of the inner brake-lining holder 11 are directed toward corresponding actuation surfaces 12, 13 of the outer brake-lining holder 10. This is made possible by the fact that the outer brake-lining holder 10 surrounds or “overlaps” the one inner brake-lining holder 11 in the manner described above. The brake-lining holders 10, 11 are thus displaced toward each other when the actuation surfaces 12, 13, 14, 15 are forced apart, for which reason the activating mechanism 8 according to the invention comprises two separating members 18 acting between said actuation surfaces 12, 13, 14, 15 for the purpose of mutual axial displacement of the brake-lining holders 10, 11 in the axial direction of the wheel axle 3.

In the illustrative embodiment that is shown, the separating members 18 consist of cam elements that are rotatable about a camshaft 19. As can be seen from FIGS. 1 and 4, the camshaft 19 extends at right angles to the wheel axle 3. The camshaft 19 is mounted with bearing bushings (not shown) in two holder arms 24 which extend in parallel and are secured in the wheel-axle housing (not shown). By means of the holder arms 24, the activating mechanism 8 is axially fixed in relation to the wheel-axle housing (not shown).

In FIG. 2, which is a sectional view taken along the dot-and-dash line 2-2 in FIG. 1, it will be seen that the cam element 18 has a substantially S-shape in cross section, with the camshaft 19 located in the central portion 20 of the S-shape. A cam element such as this is normally called an S-cam. The figure diagrammatically shows how the actuation surfaces 12, 14 of the brake-lining holders 10, 11 are forced apart in the mutually opposed directions of the arrows 21, 22 when the cam element 18 is rotated about the camshaft 19 in the direction of the arrow 23.

An activating lever 25 is connected in a rotationally fixed manner to the camshaft 19, and, in the illustrative embodiment shown, the camshaft 19 and the activating lever 25 are formed integrally by being forged from the same piece. As will be seen from FIG. 3, the activating lever 25 has a substantially cup-shaped free end portion 26 designed for actuation by an actuator rod 27 in the direction of the arrow 28 from a power member. The power member can consist, for example, of a pneumatically driven actuator cylinder. Alternatively, other power members can also be used, such as hydraulically or electrically driven actuator members.

In FIG. 1 and FIG. 4it can also be seen that in this illustrative embodiment the brake-lining holders 10, 11 are both arranged so as to slide along two mutually parallel suspension axles 29 which are likewise parallel to the wheel axle 3 and are secured in the wheel-axle housing by means of two securing lugs 30 and in the inner end portions 31 of the suspension axles 29. Alternatively, the suspension axles can be secured either by means of the securing lugs 30, at the end portions 31 or in another way along the suspension axles 29. The brake-lining holders 10, 11 are in this case provided with slide sleeves 32, 33, 34, 35, 36, 37, 38 which, by means of slide bearing bushings 39, slide along the two suspension axles 29. In contemplated alternative embodiments, other types of slide bearing bushings 39 can be replaced by other types of bearing elements, such as axial bearings provided with rolling bodies. On the outer brake-lining holder 10, the actuation surfaces 12, 13 are placed on the slide sleeves 32 and 34, respectively.

In order to illustrate the pattern of movement of the disc brake 1, reference is now made to FIGS. 1 and 4. FIG. 1 shows the disc brake 1 in an unactivated (non-active-) position, in which a gap 40 can be seen between the brake disc 2 and the brake linings 5. The activating lever 25 is located in a substantially upright position. In FIG. 4, by contrast, the disc brake 1 has been activated by means of the actuator rod 27 pressing on the activating lever 25, whereupon the latter assumes an inclined position and rotates the camshaft 19. The cam elements 18 are also rotated in such a way that they force the opposing actuation surfaces 12, 13, 14, 15 of the brake-lining holders 10, 11 apart, as has previously been described with reference to FIGS. 2 and 3. By virtue of the outer brake-lining holder 10 overlapping the inner brake-lining holder 11, the brake-lining holders 10, 11 are displaced toward each other when the actuation surfaces 12, 13, 14, 15 are forced apart, the brake linings 5 being caused to bear against the brake disc 2.

FIG. 5 shows a simplified sectional view of the disc brake 1, where the outer brake-lining holder 10 can be moved in an advantageous manner from a downwardly pivoted operating position “A” (shown by solid lines) to an upwardly pivoted maintenance position “B”(shown by dot-and-dash lines), by means of the slide sleeve 32 being divided into a fixed part 32a and a part 32b which can be detached via bolts 41. For upward pivoting, the bolts 41 are thus unscrewed, and the detachable part 32b of the slide sleeve 32 is removed from the fixed part 32a, and the outer brake-lining holder 10, which is now freely articulated about one of the suspension axles 29, is pivoted upward to its maintenance position. This makes it much easier to replace the brake linings 5, and at the same time the rest of the disc brake becomes easily accessible for inspection and maintenance. A further advantage of this solution is that the disc brake 1 does not have to be removed to permit removal of the wheel hub (not shown).

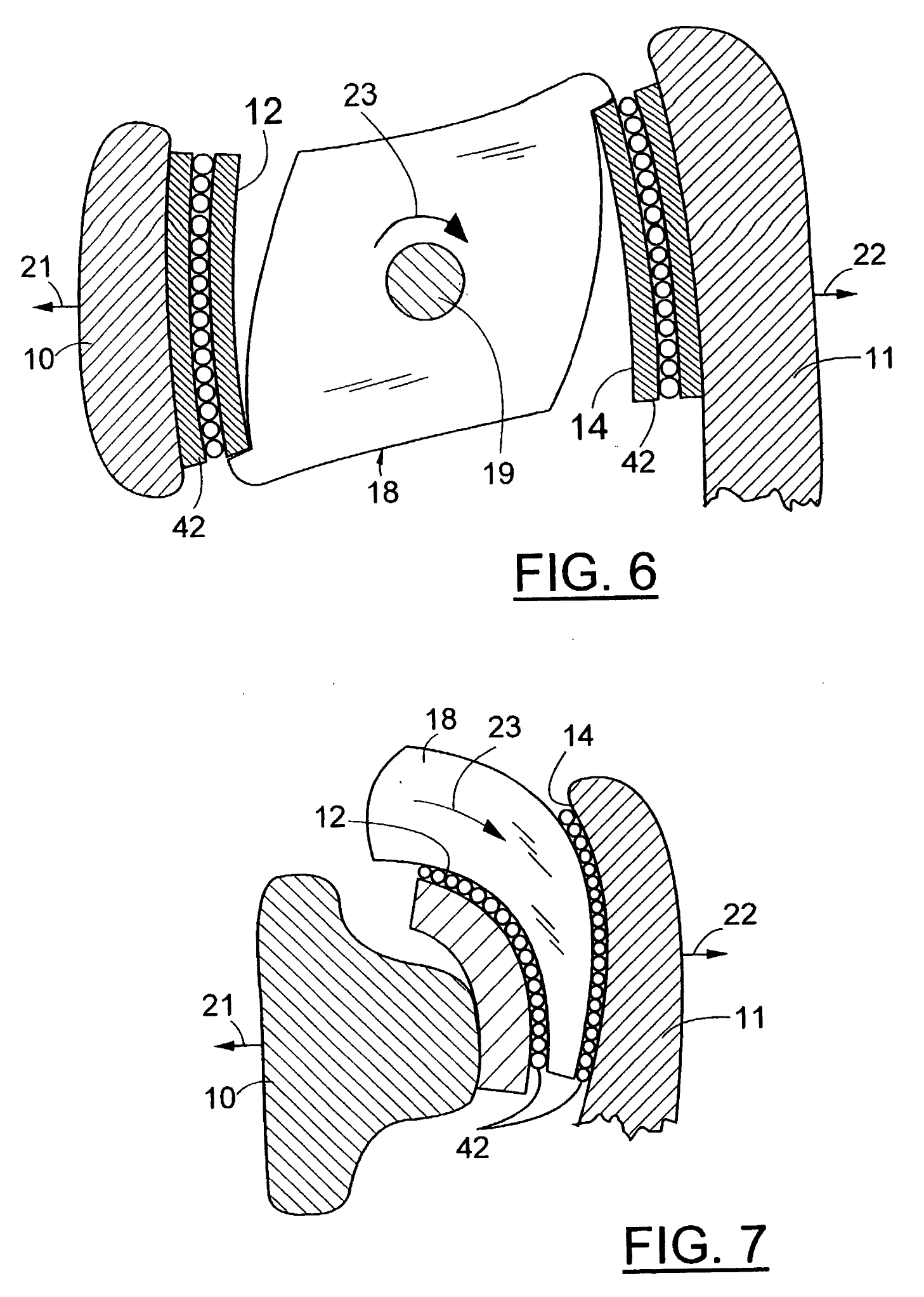

FIG. 6 shows an alternative embodiment of the cam element 18 that is analogous to with FIG. 2. This cam element 18 is also by definition of the so-called S-cam type, even if the S shape is not as clear as in FIG. 2. The cam element 18 is shown in maximum deployment. Needle-roller bearings 42 are placed between the cam element 18 and the actuation surfaces 12, 14 in order to reduce the frictional resistance of the activating mechanism 8.

FIG. 7 is a partial sectional view of a cam element 18 configured according to another alternative embodiment. Here, the cam element 18 has a curved, wedge-shaped cross section. The wedge-shaped cam element 18 is designed for actuation by a power member that displaces the cam element 18 in the direction of the arrow 23. Here too, needle-roller bearings 42 are placed between the cam element 18 and the actuation surfaces 12, 14. Friction-reducing elements other than needle bearings are of course conceivable for this purpose. For example, the actuation surfaces 12, 14 can be lined with a layer of low-friction material, so that a slide bearing is thus obtained.

In another embodiment, the cam element 18 can consist of a so-called Z-cam, where the cam element 18 has a more pronounced Z-shaped cross section.

The invention is not limited to the illustrative embodiments described above and shown in the drawings, but instead can be freely varied within the scope of the associated patent claims. For example, the brake-lining holders 10, 11 can be provided with more actuation surfaces 12, 13, 14, 15 than are shown in the illustrative embodiments described herein. However, the brake-lining holders 10, 11 are always each provided with at least one actuation surface. Furthermore, for reasons of clarity, the illustrative embodiment shown in FIGS. 1 and 4 has been drawn without an adjustment mechanism for continuous compensation of the wear of the brake linings 5. However, it goes without saying that such an adjustment mechanism is also present on the disc brake according to the invention, and it can be designed in a number of different, previously known ways.

1. A disc brake for land vehicles, comprising:
a brake disc rotating with a wheel axle;
a brake caliper which is mounted in a movable manner in a nonrotating wheel-axle housing arranged about said wheel axle, and
two brake linings, one on each side of the brake disc, said brake linings being designed in such a way that, when acted upon by an activating mechanism, they are caused to bear against the sides of the brake disc for transmitting a braking torque to the wheel axle;
said brake caliper comprises two brake-lining holders which are axially displaceable relative to one another and relative to the wheel-axle housing, and
the brake-lining holders each have at least one actuation surface for engagement with said activating mechanism, as a result of which the brake-lining holders are displaced toward each other upon activation.

2. The disc brake as recited in claim 1, wherein the brake-lining holders have attachment seats for said brake linings, which attachment seats are placed at a distance from said actuation surfaces.

3. The disc brake as recited in claim 1, wherein an outer brake-lining holder is designed such that, in the axial direction of the wheel axle, it at least partially surrounds an inner brake-lining holder.

4. The disc brake as recited in claim 3, wherein the actuation surface of the inner brake-lining holder is directed toward a corresponding actuation surface of the outer brake-lining holder.

5. The disc brake as recited in claim 4, wherein said activating mechanism is axially fixed in relation to the wheel-axle housing and comprises a separating member acting between said actuation surfaces for the purpose of mutual axial displacement of the brake-lining holders.

6. The disc brake as recited in claim 5, wherein said separating member consists of a cam element, which cam element is rotatable about a camshaft extending substantially at right angles to the wheel axle.

7. The disc brake as recited in claim 6, wherein said cam element is a so-called S-cam.

8. The disc brake as recited in claim 6, wherein said cam element is a so-called Z-cam.

9. The disc brake as recited in claim 6, wherein said cam element has a wedge-shaped cross section.

10. The disc brake as recited in claim 6, wherein needle-roller bearings are placed between the cam element and the actuation surfaces.

11. The disc brake as recited in claim 6, wherein an activating lever is connected in a rotationally fixed manner to the camshaft, which activating lever has an end portion designed for actuation by an actuator rod from a power member.

12. The disc brake as recited in claim 1, wherein the brake-lining holders are both arranged so as to slide along two mutually parallel suspension axles which are likewise parallel to the wheel axle and are secured in the wheel-axle housing.

13. The disc brake as recited in claim 12, wherein the outer brake-lining holder is articulated so that it can be pivoted upward about one of the suspension axles between a downwardly pivoted operating position and an upwardly pivoted maintenance position for replacing the brake linings.

14. A method for providing a disc brake in a land vehicle, said method comprising:
providing a brake disc that is rotatable with a wheel axle;
configuring an associated brake caliper to be movable in a non-rotating wheel-axle housing that is arranged about the wheel axle;
providing two brake linings, one on each side of the brake disc, said brake linings configured so that when acted upon by an activating mechanism are caused to bear against sides of the brake disc and thereby transmit a braking torque to the wheel axle;
providing said brake caliper with two brake-lining holders that are axially displaceable relative to one another and relative to the wheel-axle housing; and
configuring the brake-lining holders to each have at least one actuation surface for engagement with said activating mechanism when the brake-lining holders are displaced toward each other upon activation.

15. The method as recited in claim 14, wherein the brake-lining holders have attachment seats for said brake linings, said attachment seats being located at a distance from said actuation surfaces.

16. The method as recited in claim 14, wherein an outer brake-lining holder is provided and configured so that, in the axial direction of the wheel axle, said outer brake-lining holder at least partially surrounds an inner brake-lining holder.

17. The method as recited in claim 16, further comprising orienting the actuation surface of the inner brake-lining holder toward a corresponding actuation surface of the outer brake-lining holder.

18. The method as recited in claim 17, further comprising axially fixing said activating mechanism in relation to the wheel-axle housing and comprising a separating member acting between said actuation surfaces for the purpose of mutual axial displacement of the brake-lining holders.

19. The method as recited in claim 18, wherein said separating member comprises a cam element that is rotatable about a camshaft extending substantially at right angles to the wheel axle.

20. The method as recited in claim 19, further comprising selecting said cam element to be S-cam type.

21. The method as recited in claim 19, further comprising selecting said cam element to be Z-cam type.

22. The method as recited in claim 19, further comprising establishing said cam element to have a wedge-shaped cross section.

23. The method as recited in claim 19, further comprising utilizing needle-roller bearings that are placed between the cam element and the actuation surfaces.

24. The method as recited in claim 19, further comprising an activating lever connected in a rotationally fixed manner to the camshaft having an end portion configured for actuation by an actuator rod from a power member.

25. The method as recited in claim 19, further comprising arranging the brake-lining holders to slide along two mutually parallel suspension axles that are oriented parallel to the wheel axle and are securable in a wheel-axle housing.

26. The method as recited in claim 25, further comprising the outer brake-lining holder being articulated to pivot upward about one of the suspension axles between a downwardly pivoted operating position and an upwardly pivoted maintenance position for replacing the brake linings.
